(19) United States
(12) Patent Application Publication
(10) Pub. No.: US 2003/0048529 A1
(43) Pub. Date: Mar. 13, 2003

(54) Optical circulator

(76) Inventors: Shusuke Wada, Shizuoka (JP); Shohei Abe, Shizuoka (JP); Hideo Takeshita, Aichi (JP); Hiroaki Ono, Aichi (JP); Yuko Ota, Shizuoka (JP)

Correspondence Address: HARNESS, DICKEY & PIERCE, P.L.C., P.O. BOX 828, BLOOMFIELD HILLS, MI, 48303, US

(21) Appl. No.: 10/241,185

(22) Filed: Sep. 11, 2002

(30) Foreign Application Priority Data
Sep. 11, 2001 (JP) 2001-275,437

(51) Int. Cl. G02B 21/06

(52) U.S. Cl. 359/386

(57) ABSTRACT

An optical circulator comprises a first birefringent element for separation and synthesis; a first polarization rotation block; a circulator function block; a second polarization rotation block; and a second birefringent element for separation and synthesis; the circulator function block includes a first birefringent element for optical path control; a second birefringent element for optical path control which shifts the optical paths depending on the polarization directions and which has twice the optical path shifting amount of the first birefringent element for optical path control; and a ¼ wave plate and a reflector allowing light beams along peripheral optical paths to bypass and acting on only light beams along central optical paths.

### CROSS-REFERENCE TO RELATED APPLICATIONS

This application claims the priority based on Japanese Patent Application No. 2001-275437 filed on Sep. 11, 2001, the contents of which are incorporated herein by reference.

### BACKGROUND OF THE INVENTION

1. Field of the Invention

The present invention relates generally to an optical circulator for use in, e.g., optical communications or optical measurements, and more particularly to an optical circulator of full circulation type having a ¼ wave plate and a reflector disposed on at least some of optical paths of a circulator function block. This technique is useful for, e.g., an add drop multiplexing/branching module which serves to synthesize and branch specific wavelength light beams from multiplexed signal light beams having a plurality of wavelengths.

2. Description of the Related Arts

Optical circulators are optical devices having optical path control capabilities for outputting input light beams from a certain port to another specific port only, such as in cases where input light beams from a first port P1 are output to a second port P2, with input light beams from the second port P2 being output to a third port P3. The optical circulators have a 45-degree Faraday rotator incorporated therein for applying a fixed magnetic field by its permanent magnet, so as to provide a light beam non-reciprocity through 45-degree rotation of the plane of polarization to a predetermined direction.

Variously configured optical circulators have been developed so far. One exemplary configuration includes three birefringent elements which are aligned in a spaced apart relationship, with a 45-degree Faraday rotator and a ½ wave plate in pairs interposed between the adjacent birefringent elements, with ports arranged at opposed ends. The birefringent elements at both ends serve to separate light beams having orthogonal polarization directions on the same optical path and synthesize light beams on different optical paths. The middle birefringent element serves to shift the optical path depending on the polarization direction. The paired 45-degree Faraday rotator and ½ wave plate fulfill the polarization rotation function to convert the polarization direction from orthogonal to parallel or parallel to orthogonal. An optical circulator can thus be configured which allows input light beams from the first port located at one end to be coupled to the second port at the opposite end and input light beams from the second port to the third port. In the above configuration, however, light beams input from the third port cannot be coupled to the first port. This means that this configuration provides an optical circulator of non-circulation type.

In the wavelength division multiplexing (WDM) optical communications for example, the add drop multiplexing/branching module for synthesizing and branching a specific wavelength light beam from multiplexed signal light beams having a plurality of wavelengths can be made up by combining the optical circulator with a band pass filter (which has characteristics permitting the passage of a specific wavelength light beam therethrough but reflecting light beams having the other wavelengths). However, due to the above conventional configuration being of non-circulation type, the module can be disposed only on a one directional transmission line.

Application to a bi-directional transmission line would require a combination of three non-circulation type optical circulators which are arranged so as to lie at vertexes of a triangle, resulting in an increased number of components, which may increase the size and costs.

### SUMMARY OF THE INVENTION

It is therefore an object of the present invention to provide an optical circulator of full circulation type. Another object of the present invention is to provide an optical circulator capable of reducing the number of components, the dimensions and the manufacturing costs.

The present invention was conceived in order to achieve the above and other objects. According to a first aspect of the present invention there is provided an optical circulator comprising a first birefringent element for separation and synthesis which separates light beams having orthogonal polarization directions on the same optical path and synthesizes light beams on different optical paths; a first polarization rotation block which converts polarization directions from orthogonal into parallel or from parallel into orthogonal; a circulator function block; a second polarization rotation block which converts polarization directions from orthogonal into parallel or from parallel into orthogonal; and a second birefringent element for separation and synthesis which separates light beams having orthogonal polarization directions on the same optical path and synthesizes light beams on different optical paths; the first birefringent element for separation and synthesis, the first polarization rotation block, the circulator function block, the second polarization rotation block and the second birefringent element for separation and synthesis being arrayed in the mentioned order; wherein the circulator function block includes a first birefringent element for optical path control which shifts the optical paths depending on the polarization directions; a second birefringent element for optical path control which shifts the optical paths depending on the polarization directions and which has twice the optical path shifting amount of the first birefringent element for optical path control; and a ¼ wave plate and a reflector which are interposed between the first and second birefringent elements for optical path control, the ¼ wave plate and reflector allowing light beams along peripheral optical paths to bypass and acting on only light beams along central optical paths.

In this case, the first polarization rotation block and the second polarization rotation block may each be comprised of a combination of a 45-degree Faraday rotator and paired ½ wave plates having symmetrically juxtaposed optical axes on both side optical paths such that the polarization directions are rotated through 45 degrees.

The first and second birefringent elements for optical path control may be made of different materials but instead, may be formed of the same material. For example, the second birefringent element for optical path control can be twice as long as the first birefringent element for optical path control. The optical path lengths of the peripheral optical paths bypassing the ¼ wave plate and reflector of the circulator function block may be substantially equal to the optical path lengths of the central optical paths which pass through the ¼ wave plate and are reflected by the reflector for return again through the ¼ wave plate.

According to a second aspect of the present invention there is provided an optical circulator comprising a birefringent element for separation and synthesis which separates light beams having orthogonal polarization directions on the same optical path and synthesizes light beams on different optical paths; a polarization rotation block which converts polarization directions from orthogonal into parallel or from parallel into orthogonal; and a circulator function block; the birefringent element for separation and synthesis, the polarization rotation block and the circulator function block being arrayed in the mentioned order; wherein the circulator function block includes a birefringent element for optical path control which shifts the optical paths depending on the polarization directions; a ¼ wave plate; a reflector which allows light beams along peripheral optical paths to bypass, the reflector acting on only light beams along central optical paths; and an optical path shift reflector which reflects light beams along one peripheral optical paths to shift the optical paths for return to the other peripheral optical paths.

In this case as well, the polarization rotation block may be comprised of a combination of a 45-degree Faraday rotator and paired ½ wave plates having symmetrically juxtaposed optical axes on both side optical paths such that the polarization directions are rotated through 45 degrees.

### BRIEF DESCRIPTION OF THE DRAWINGS

The above and other objects, aspects, features and advantages of the present invention will become more apparent from the following detailed description when taken in conjunction with the accompanying drawings, in which:

FIGS. 1A and 1B are optical path explanatory diagrams showing an embodiment of an optical circulator in accordance with the present invention;

FIGS. 2A and 2B are explanatory diagrams respectively showing the structure of a polarization rotation block of the optical circulator and the direction of Faraday rotation as well as the orientation of the optical axis;

FIGS. 3A to 3C are optical path explanatory diagrams on a path-by-path basis of a circulator function block of the optical circulator;

FIGS. 4A to 4C are explanatory diagrams of the states of polarization between optical components of the optical circulator;

FIGS. 5A and 5B are optical path explanatory diagrams showing another embodiment of the optical circulator in accordance with the present invention;

FIGS. 6A to 6C are optical path explanatory diagrams on a path-by-path basis of a circulator function block of the optical circulator; and

FIGS. 7A to 7C are explanatory diagrams of the states of polarization between optical components of the optical circulator.

### DESCRIPTION OF THE PREFERRED EMBODIMENTS

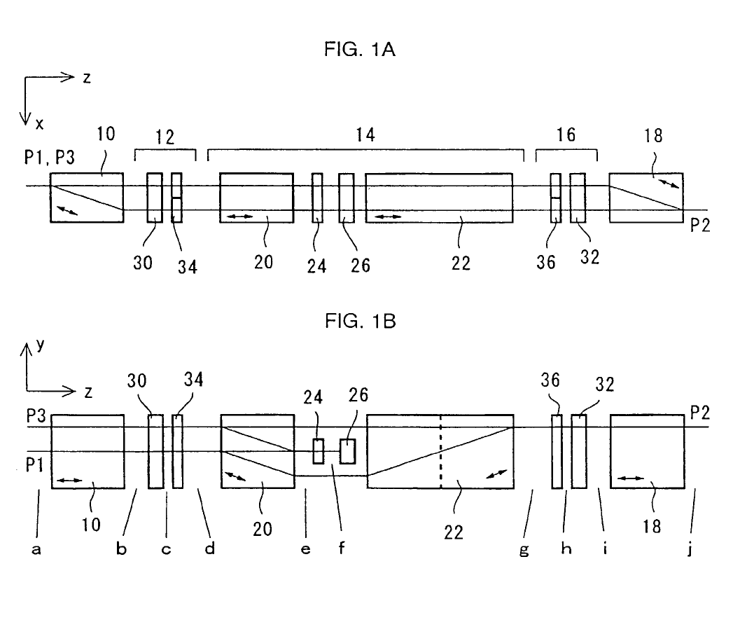

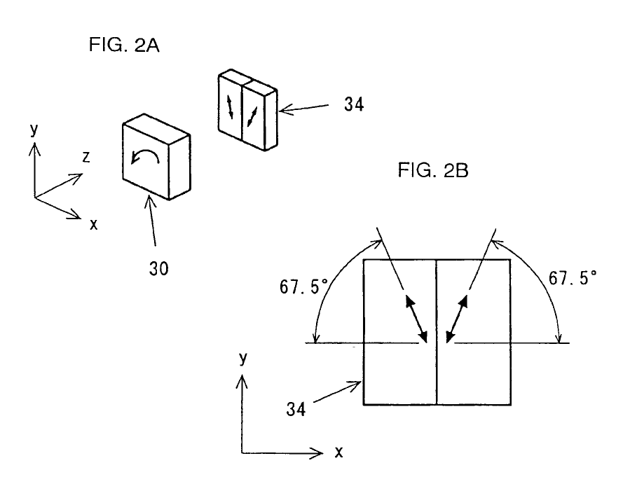

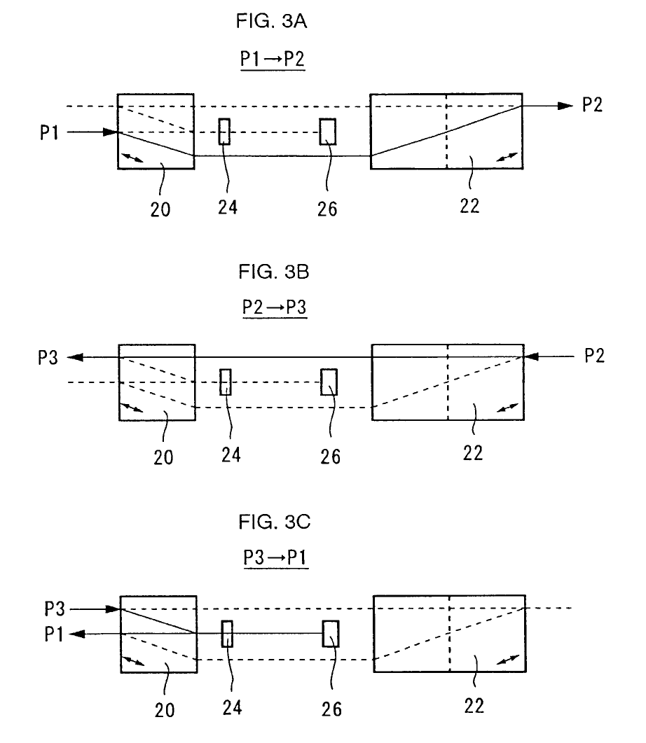

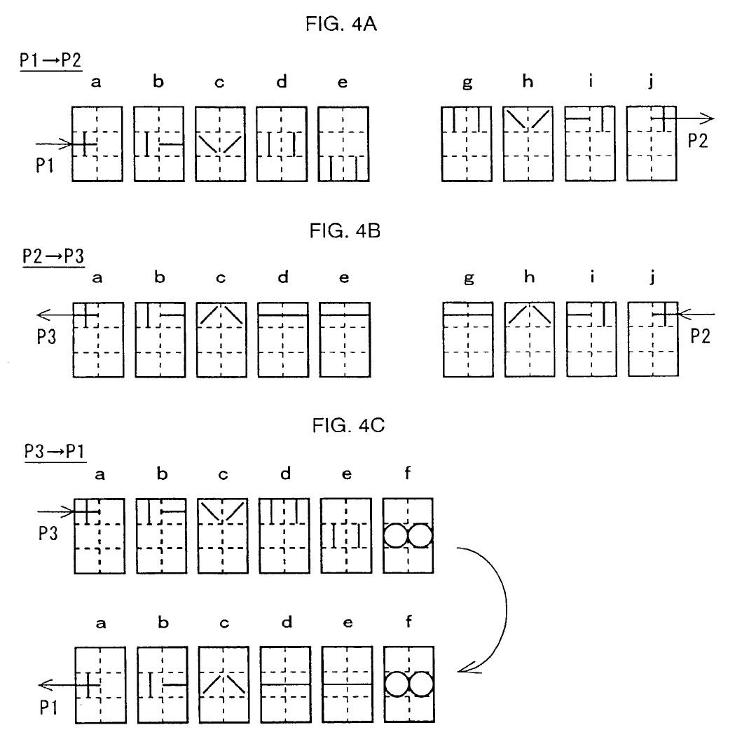

FIGS. 1A and 1B are optical path explanatory views showing an embodiment of an optical circulator in accordance with the present invention, FIGS. 2A and 2B are explanatory views respectively showing the structure of a polarization rotation block of the optical circulator and the direction of Faraday rotation as well as the orientation of the optical axis, FIGS. 3A to 3C are optical path explanatory views on a path-by-path basis of a circulator function block of the optical circulator, and FIGS. 4A to 4C are explanatory views of the states of polarization between optical components of the optical circulator. To facilitate understanding of the description, the coordinate axes are defined as follows. Let z direction (rightward direction in the diagram) be the direction where the optical components are arrayed, x direction (horizontal direction in the diagram) and y direction (vertical direction in the diagram) be two directions orthogonal to z direction. Thus, FIGS. 1A and 1B are a top plan view and a front view, respectively. The positive rotational direction of the plane of polarization is counterclockwise when viewed z direction. The states of polarization indicated by a to j of FIGS. 4A to 4C are obtained when viewed the direction where light beams advance at the positions a to j of FIG. 1B.

The optical circulator comprises, arrayed in z direction in the mentioned order, a first birefringent element 10 for separation and synthesis which separates light beams having orthogonal polarization directions on the same optical path into x direction and synthesizes light beams on different optical paths, a first polarization rotation block 12 for converting the polarization directions from orthogonal relationship into parallel relationship (from parallel into orthogonal in the reverse direction), a circulator function block 14, a second polarization rotation block 16 for converting the polarization direction from parallel relationship into orthogonal relationship (from orthogonal into parallel in the reverse direction), and a second birefringent element 18 for separation and synthesis which separates light beams having orthogonal polarization directions on the same optical path into x direction and synthesize light beams on different optical paths. The circulator function block 14 includes a first birefringent element 20 for optical path control which shifts the optical path to -y direction depending on the polarization direction, a second birefringent element 22 for optical path control which shifts the optical path to y direction depending on the polarization direction and which has twice the optical path shifting amount of the first birefringent element for optical path control, and a ¼ wave plate 24 and a reflector (mirror) 26 which are interposed between the first and second birefringent elements 20 and 22 for optical path control, the ¼ wave plate 24 acting only on light beams along central optical paths, with light beams along peripheral optical paths (upper optical path and lower optical path) bypassing the ¼ wave plate 24.

All the birefringent elements 10, 18, 20 and 22 are of plane-parallel type and made of rutile crystal for example. As used herein, the “plane-parallel” refers to a geometric configuration having an entry surface and an exit surface which are parallel to each other. In this case, the entry surface need not be strictly normal to the incident light. The plane-parallel shape can include not only a parallel plate shape, but also a parallelogrammic block shape, a rectangular parallelepiped shape, etc. The second birefringent element 22 for optical path control is dimensioned to be twice as long as the first birefringent element 20 for optical path control so as to be able to acquire twice the optical path shifting amount of the first birefringent element 20 for optical path control.

The first and second polarization rotation blocks 12, 16 are comprised of respective combinations of 45-degree Faraday rotators 30, 32 and ½ wave plates 34, 36 in pairs having symmetrically juxtaposed optical axes on outside optical paths so as to allow the polarization direction to rotate through 45 degrees. Similar to the prior art, the 45-degree Faraday rotators 30 and 32 are each formed of a Faraday element (typically, a magneto-optical crystal such as Bi-substituted rare-earth iron garnet) and a permanent magnet such that magnetic fields from the permanent magnet are applied to the Faraday element to cause a 45-degree Faraday rotational angle. The paired ½ wave plates 34 and 36 have an optical axis tilted −67.5 degrees relative to -x axis on the left-hand optical path and an optical axis tilted 67.5 degrees relative to x axis on the right-hand optical path as shown in FIG. 2B, the two ½ wave plates being integrated such that the two optical axes are symmetric with respect to y axis.

Toward the first birefringent element 10 for separation and synthesis when viewed z direction, a first port and a third port are provided at the intermediate and upper sites, respectively, in a spaced apart relationship in y direction, whilst a second port is provided at the upper stage toward the second birefringent element for separation and synthesis.

Description will then be made of the operation of the optical circulator.

===First Port P1 to Second Port P2===

Of light beams input in z direction from the first port P1 at the intermediate stage, an ordinary light beam goes straight through the first birefringent element 10 for separation and synthesis whereas an extraordinary light beam is refracted thereat and optically separated in x direction. Then, at the first polarization rotation block 12, their polarization directions are converted from orthogonal into parallel relationship. Thus, two light beams having orthogonal polarization directions are subjected by the 45-degree Faraday rotator 30 to 45-degree rotations of their respective polarization directions and then enter the ½ wave plate 34. Due to the properties of the ½ wave plate to convert the polarization directions of the input light beams into symmetry with respect to their optical axes, the input light beams are rotated 45 degrees in reverse direction to each other and become perpendicular to x axis. The two light beams act as extraordinary light beams on the first birefringent element 20 for optical path control and hence are refracted downward (to -y direction) to travel along the lower optical path. Since the ¼ wave plate 24 and the reflector 26 are disposed on only the intermediate optical path, the light beams along the lower optical path can bypass them without being affected. These light beams act as extraordinary light beams on the second birefringent element 22 for optical path control as well and, in turn, are refracted upward (toy direction), with the result that their optical paths can shift up to the upper optical path due to the doubled length of the element 22. Then at the second polarization rotation block 16, the polarization directions are converted from parallel into orthogonal relationship. More specifically, the ½ wave plate 36 and the 45-degree Faraday rotator 32 rotate the polarization directions through 45 degrees, respectively, allowing the two light beams to have an orthogonal relationship. Finally, at the second birefringent element 18 for separation and synthesis the two light beams are synthesized in x direction for the output from the upper second port P2.

===Second Port P2 to Third Port P3===

Of light beams input in -z direction from the second port P2 at the upper stage, an ordinary light beam goes straight through the second birefringent element 18 for separation and synthesis whereas an extraordinary light beam is refracted thereat and optically separated in -x direction. Then, at the second polarization rotation block 16, their polarization directions are converted from orthogonal into parallel relationship. Thus, two light beams having orthogonal polarization directions are subjected by the 45-degree Faraday rotator 32 to 45-degree rotations of their respective polarization directions and then enter the ½ wave plate 36. The input light beams are rotated 45 degrees in reverse direction to each other and become perpendicular to x axis. The two light beams act as ordinary light beams on the second birefringent element 22 for optical path control and hence are allowed to go straight intactly along the upper optical path. Because of the disposition on only the intermediate optical path, the reflector 26 and the ¼ wave plate 24 are bypassed. These light beams act as ordinary light beams on the first birefringent element 20 for optical path control as well and are allowed to go straight unchangingly along the upper optical path. Then at the first polarization rotation block 12, the polarization directions are converted from parallel into orthogonal relationship. More specifically, the ½ wave plate 34 and the 45-degree Faraday rotator 30 rotate the polarization directions through 45 degrees, respectively, allowing the two light beams to have an orthogonal relationship. Finally, at the first birefringent element 10 for separation and synthesis the two light beams are synthesized in -x direction for the output from the upper third port P3.

===Third Port P3 to First Port P1===

Of light beams input in z direction from the third port P3 at the upper stage, an ordinary light beam goes straight through the first birefringent element 10 for separation and synthesis whereas an extraordinary light beam is refracted thereat and optically separated in x direction. Then, at the first polarization rotation block 12, their polarization directions are converted from orthogonal into parallel relationship such that the input light beams become perpendicular to x axis. The two light beams act as extraordinary light beams on the first birefringent element 20 for optical path control and hence are refracted downward (to -y direction) to travel along the intermediate optical path. Then at the ¼ wave plate 24, linearly polarized light beams are converted into circularly polarized light beams, which in turn are reflected by the reflector 26 and again pass through the ¼ wave plate 24. At that time, the circularly polarized light beams are restored to the linearly polarized light beams. These light beams act as ordinary light beams on the first birefringent element 20 for optical path control and hence go straight intactly along the intermediate optical path. At the first polarization rotation block 12, the polarization directions are converted from parallel into orthogonal relationship. Finally, at the first birefringent element 10 for separation and synthesis the two light beams are synthesized in -x direction for the output from the intermediate first port P1.

The full circulation type optical circulator can thus be realized which ensures optical circulation from the first port P1 to the second port P2, from the second port P2 to the third port P3, and from the third port P3 to the first port P1.

It is preferable in such a configuration that the optical path lengths be equal between the ports. To this end, adjustment may be made of the intervals between the first birefringent element for optical path control and the second birefringent element for optical path control, and of the positions of the reflector, etc., inserted between the two birefringent elements. It would also be possible for each birefringent element to have an entry surface tilted relative to the incident light beam such that the angle of tilt can be adjusted to thereby equalize the optical path of each polarization to cancel the polarization dispersion.

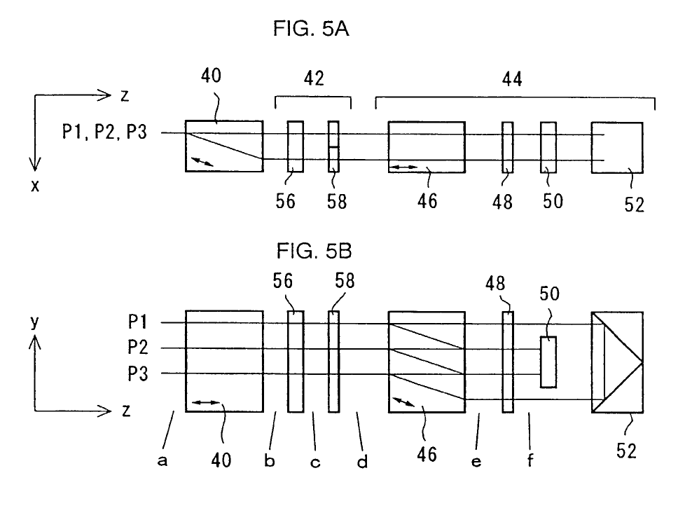

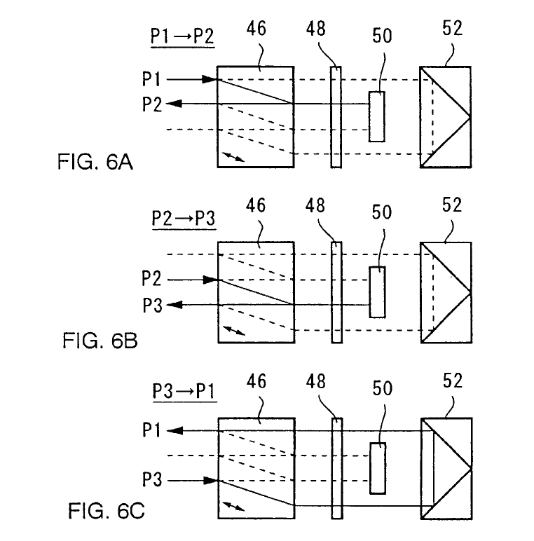

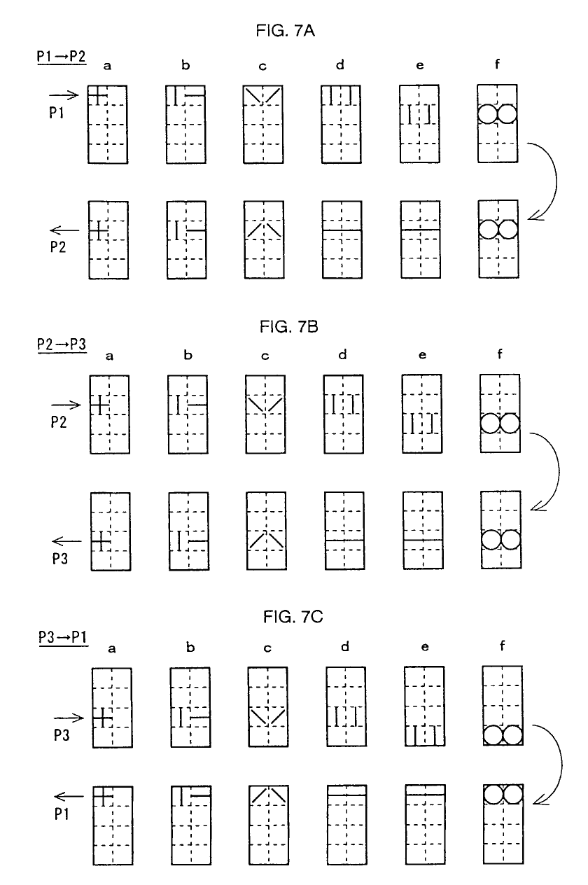

FIGS. 5A and 5B are optical path explanatory views showing another embodiment of the optical circulator in accordance with the present invention, FIGS. 6A to 6C are optical path explanatory views on a path-by-path basis of a circulator function block of the optical circulator, and FIGS. 7A to 7C are explanatory views of the states of polarization between optical components of the optical circulator. This optical circulator is of full reflection type having three ports all of which are located at one side only. In the same manner as the above embodiment, z direction (rightward in the diagram) represents the direction where the optical components are arrayed, with x direction (horizontal direction in the diagram) and y direction (vertical direction in the diagram) representing two directions orthogonal to z direction. Thus, FIGS. 5A and 5B are a top plan view and a front view, respectively. The states of polarization indicated by a to f of FIGS. 7A to 7C are obtained when viewed the direction where light beams advance at the positions a to f of FIG. 5B.

The optical circulator comprises, arrayed in z direction in the mentioned order, a birefringent element 40 for separation and synthesis which separates light beams having orthogonal polarization directions on the same optical path in x direction and synthesizes light beams on different optical paths, a polarization rotation block 42 for converting the polarization directions from orthogonal relationship into parallel relationship (from parallel into orthogonal in the reverse direction) and a circulator function block 44. The circular function block 44 includes a birefringent element 46 for optical path control which shifts the optical path depending on the polarization direction, a ¼ wave plate 48, a reflector (mirror) 50 which allows light beams along peripheral optical paths to bypass but acts on light beams only along central optical paths, and an optical path shift reflector 52 which reflects light beams along one peripheral optical paths to shift the optical paths, for return to the other near-peripheral optical paths. The optical path shift reflector 52 can be for example a 45-degree prism or a combination of two mirrors tilted 45 degrees relative to their respective optical axes.

Similar to the above embodiment, the polarization rotation block 42 is comprised of a combination of a 45-degree Faraday rotator 56 and paired ½ wave plates 58 having symmetrically juxtaposed optical axes on both side optical paths so as to allow the polarization directions to rotate through 45 degrees. The 45-degree Faraday rotator 56 is arranged such that magnetic fields from the permanent magnet are applied to the Faraday element to cause a 45-degree Faraday rotational angle. The paired ½ wave plates 58, similar to those shown in FIG. 2B, have an optical axis tilted −67.5 degrees relative to -x axis on the left-hand optical path and an optical axis tilted 67.5 degrees relative to x axis on the right-hand optical path, the two ½ wave plates being integrated such that the two optical axes are symmetric with respect to y axis.

Toward the birefringent element for separation and synthesis when viewed z direction, a first port P1, a second port P2 and a third port P3 are provided in the mentioned order from top downward (to -y direction).

Description will then be made of the operation of the optical circulator.

===First Port P1 to Second Port P2===

Of light beams along a first stage optical path input in z direction from the first port P1, an ordinary light beam goes straight through the birefringent element 40 for separation and synthesis but an extraordinary light beam is refracted thereat and optically separated in x direction. Then, at the polarization rotation block 42, their polarization directions are converted from orthogonal into parallel relationship. Thus, two light beams having orthogonal polarization directions are subjected by the 45-degree Faraday rotator 56 to 45-degree rotations of their respective polarization directions and then enter the ½ wave plate 58. Due to the properties of the ½ wave plate to convert the polarization directions of the input light beams to be symmetric with respect to their optical axes, the input light beams are rotated 45 degrees in reverse direction to each other and become perpendicular to x axis. The two light beams act as extraordinary light beams on the birefringent element 46 for optical path control and hence are refracted downward (to -y direction) to travel along the second stage optical path. At the ¼ wave plate 48, linearly polarized light beams are converted into circularly polarized light beams, which in turn are reflected by the reflector 50 and again pass through the ¼ wave plate 48. At that time, the circularly polarized light beams are restored to the linearly polarized light beams. These light beams act as ordinary light beams on the birefringent element 46 for optical path control and hence go straight intactly along the second stage optical path. At the polarization rotation block 42, the polarization directions are converted from parallel into orthogonal relationship. Finally, at the birefringent element 40 for separation and synthesis the two light beams are synthesized in -x direction for the output from the second port P2.

===Second Port P2 to Third Port P3===

Of light beams along the second stage optical path input in z direction from the second port P2, an ordinary light beam goes straight through the birefringent element 40 for separation and synthesis but an extraordinary light beam is refracted thereat and optically separated in x direction. Then, at the polarization rotation block 42, their polarization directions are converted from orthogonal into parallel relationship. Since the two light beams act as extraordinary light beams on the birefringent element 46 for optical path control, they are refracted thereat downward (to -y direction) to travel along a third stage optical path. At the ¼ wave plate 48, linearly polarized light beams are converted into circularly polarized light beams, which in turn are reflected by the reflector 50 and again pass through the ¼ wave plate 48. At that time, the circularly polarized light beams are restored to the linearly polarized light beams. These light beams act as ordinary light beams on the birefringent element 46 for optical path control and hence go straight unchangingly along the third stage optical path. At the polarization rotation block 42, the polarization directions are converted from parallel into orthogonal relationship. Finally, at the birefringent element 40 for separation and synthesis the two light beams are synthesized in x direction for the output from the third port P3.

===Third Port P3 to First Port P1===

Of light beams along the third optical path input in z direction from the third port P3, an ordinary light beam goes straight through the birefringent element 40 for separation and synthesis but an extraordinary light beam is refracted thereat and optically separated in x direction. Then, at the polarization rotation block 42, their polarization directions are converted from orthogonal into parallel relationship. The two light beams act as extraordinary light beams on the birefringent element 46 for optical path control and hence are refracted thereat downward (to -y direction) to travel along a fourth stage optical path. At the ¼ wave plate 48, linearly polarized light beams are converted into circularly polarized light beams, which in turn bypass the reflector 50 and enter the optical path shift reflector 52. The light beams from the fourth stage optical path are reflected at right angles upward by the lower reflector and further reflected at right angles by the upper reflector to return to the first stage optical path. The light beams again pass through the ¼ wave plate 48, at the time of which the circularly polarized light beams are restored to the linearly polarized light beams. These light beams act as ordinary light beams on the birefringent element 46 for optical path control and hence go straight unchangingly along the first stage optical path. At the polarization rotation block 42, the polarization directions are converted from parallel into orthogonal relationship. Finally, at the birefringent element 40 for separation and synthesis the two light beams are synthesized in -x direction for the output from the first port P1.

In the same manner as the above embodiment, the full circulation type optical circulator can thus be realized which ensures optical circulation from the first port P1 to the second port P2, from the second port P2 to the third port P3, and from the third port P3 to the first port P1. Advantageously, this configuration contributes to a reduction in the number of components and thus to a further reduction in size.

According to the abovementioned embodiments, the full circulation type optical circulator can be realized by disposing the ¼ wave plate and the reflector on at least some of optical paths of the circulator function block such that light beams along some or all of the optical paths are reflected. For this reason, it would become possible in the wavelength division multiplexing (WDM) optical communications system to incorporate the add drop multiplexing/branching module which synthesizes and branches specific wavelength light beams from multiplexed signal light beams having a plurality of wavelengths, into the bi-directional transmission path as well, by making up the add drop multiplexing/branching module using the optical circulator of the above embodiments.

The optical circulator in accordance with the present embodiments includes a relatively small number of components, achieving a reduced size and manufacture at lower costs. It would also be possible to select the optimal apparatus configuration depending on the state of use (i.e., either the case where the ports are to be provided at both sides or the case where the ports are to be arranged only at one side), thus minimizing the space in which the optical fibers extend.

Although the present invention has been set forth hereinabove by way of exemplary embodiments, it will be apparent to those skilled in the art that the invention described herein can variously be changed or modified without departing from the spirit of the present invention. Therefore, such changes or modifications are to be construed as being included within the scope of the invention.

What is claimed is:

1. An optical circulator comprising:
a first birefringent element for separation and synthesis which separates light beams having orthogonal polarization directions on the same optical path and synthesizes light beams on different optical paths;
a first polarization rotation block which converts polarization directions from orthogonal into parallel or from parallel into orthogonal;
a circulator function block;
a second polarization rotation block which converts polarization directions from orthogonal into parallel or from parallel into orthogonal; and
a second birefringent element for separation and synthesis which separates light beams having orthogonal polarization directions on the same optical path and synthesizes light beams on different optical paths;
said first birefringent element for separation and synthesis, said first polarization rotation block, said circulator function block, said second polarization rotation block and said second birefringent element for separation and synthesis being arrayed in the mentioned order; wherein
said circulator function block includes:
a first birefringent element for optical path control which shifts said optical paths depending on said polarization directions;
a second birefringent element for optical path control which shifts said optical paths depending on said polarization directions and which has twice the optical path shifting amount of said first birefringent element for optical path control; and
a ¼ wave plate and are factor which are interposed between said first and second birefringent elements for optical path control, said ¼ wave plate and reflector allowing light beams along peripheral optical paths to bypass and acting on only light beams along central optical paths.

2. The optical circulator according to claim 1, wherein
said first polarization rotation block and said second polarization rotation block are each comprised of a combination of a 45-degree Faraday rotator and paired ½ wave plates having symmetrically juxtaposed optical axes on both side optical paths such that said polarization directions are rotated through 45 degrees.

3. The optical circulator according to claim 1, wherein
said first and second birefringent elements for optical path control are made of the same material; and wherein
said second birefringent element for optical path control is twice as long as said first birefringent element for optical path control.

4. The optical circulator according to claim 1, wherein
the optical path lengths of said peripheral optical paths bypassing said ¼ wave plate and reflector of said circulator function block are substantially equal to the optical path lengths of said central optical paths which pass through said ¼ wave plate and are reflected for return by said reflector.

5. An optical circulator comprising:
a birefringent element for separation and synthesis which separates light beams having orthogonal polarization directions on the same optical path and synthesizes light beams on different optical paths;
a polarization rotation block which converts polarization directions from orthogonal into parallel or from parallel into orthogonal; and
a circulator function block;
said birefringent element for separation and synthesis, said polarization rotation block and said circulator function block being arrayed in the mentioned order; wherein
said circulator function block includes:
a birefringent element for optical path control which shifts said optical paths depending on said polarization directions;
a ¼ wave plate;
a reflector which allows light beams along peripheral optical paths to bypass, said reflector acting on only light beams along central optical paths; and
an optical path shift reflector which reflects light beams along one peripheral optical paths to shift said optical paths for return to the other peripheral optical paths.

6. The optical circulator according to claim 5, wherein
said polarization rotation block is comprised of a combination of a 45-degree Faraday rotator and paired ½ wave plates having symmetrically juxtaposed optical axes on both side optical paths such that said polarization directions are rotated through 45 degrees.
